(19) United States
(12) Patent Application Publication
(10) Pub. No.: US 2021/0162535 A1
(43) Pub. Date: Jun. 3, 2021

(54) IMPROVEMENTS IN OR RELATING TO LASER MARKING

(71) Applicant: DATALASE LIMITED, Widnes Cheshire (GB)

(72) Inventors: John Cridland, Widnes Cheshire (GB); Tristan Phillips, Widnes Cheshire (GB)

(73) Assignee: DATALASE LIMITED, Widnes Cheshire (GB)

(21) Appl. No.: 17/047,323

(22) PCT Filed: Apr. 18, 2019
(86) PCT No.: PCT/GB2019/051105

§ 371 Date: Oct. 13, 2020

(30) Foreign Application Priority Data
Apr. 18, 2018 (GB) 1806337.0

(51) Int. Cl. B23K 26/06; B41J 2/45; G02B 13/22; B41J 2/455

(52) U.S. Cl. CPC B23K 26/0648; B41J 2/455; G02B 13/22; B41J 2/451

(57) ABSTRACT

A laser marking system (10) comprises a marking controller (11) operable to control a plurality of laser diodes (13) to emit light through optical fibre (14) such that the emitting, ends of the optical fibres (14) form a multi-emitter array. Light emitted from the emitting ends of the optical fibres (14) is focussed by a lensing arrangement (15) on a substrate (16). The lensing arrangement (15) is substantially telecentric such that the non-telecentric angle, θₜ, of the telecentric lens assembly satisfies (Formula I) where θ_{1/2} is the half angle divergence of the emitter beam and 1/F is the fraction of the emitter spot diameter dₒ that corresponds to the maximum acceptable displacement in the image plane.

### TECHNICAL FIELD OF THE INVENTION

The present invention relates to improvements in or relating to laser marking. In particular, the present invention relates to a laser marking system comprising a multi-emitter array.

### BACKGROUND TO THE INVENTION

Laser marking and imaging systems are well known. Such systems are used in conjunction with substrates, for example labels, that comprise colour change material. Upon controlled exposure to laser light from the marking system, portions of the substrate change colour forming a desired image. The image may be monotone or coloured depending on the material and/or the nature of the exposure. The image may comprise text, numbers, codes or the like as well as pictographic elements.

The marking systems may comprise multi-emitter laser arrays. In some instances, the multi-emitter array may simply comprise an array of adjacent laser sources, such as laser diodes. More usually, the the array may comprise the emitting ends of multiple fibres, the fibres being coupled at their other ends to one or more laser sources.

Fibre arrays and their coupling to laser diodes (or other lasers) is well known. Making these fibre arrays arbitrarily large has challenges with maintaining smile and manufacturing yield as one broken fibre would ‘write off’ the array. Typically, a maximum of between 100 and 200 channels can be made in a single array whilst maintaining good yields with pitch and width tolerances of 5 um and smile tolerance of ˜5 um. To make laser imaging systems of many hundreds and up to and above 1000 fibres and laser diodes it is necessary to consider an alternative approach to this problem and assemble larger arrays from smaller sub-array units. U.S. Pat. No. 4,389,655 describes an optical device for non-contact recording that uses smaller arrays arranged in a staggered configuration, thus forming a larger array. When the sub-arrays are supported in a carrier it is not possible to butt them together and maintain continuity of the dot patterns. In such a configuration the sub-arrays have to be displaced in the direction perpendicular to the plane of the array. The sub-arrays can then be positioned in the direction of the plane of the arrays such that the join in the image is not discernible.

More recently, fibre arrays have been used with higher power laser diodes (˜5 W) to produce high speed imaging system with a print speed that is independent of image content. This allows images to be produced on products moving at speeds up to and above 2 m/s. There is considerable commercial interest in solving the problems associated with staggered and combined arrays.

In a multi-emitter array marking system, the product or substrate to be imaged moves in front of the array in a direction perpendicular to the plane of the array. If such a system uses staggered sub-arrays it is necessary to adjust the firing of the lasers such that the image from each sub-array comes into alignment on the substrate. This requires precise control of the laser firing. For a system with 200 dpi resolution with a dot size of 100 to 120 um, the unaided human eye can detect misalignments greater than 20 um. If the misalignment is less than around 10 um, the misalignment is difficult to detect by the unaided eye and image artefacts are not present.

In many cases, the beams emitted from a multi-emitter array are divergent and rapidly loose intensity. Additionally, such beams from adjacent emitters overlap as they diverge and therefore cannot be used for imaging directly. A lensing assembly required to focus the output light from the emitters onto the substrate to ensure distinct dots are produced. The lensing arrangement may be a singlet lens assembly comprising either a single lens or may be a lens combination acting as a single imaging lens.

In systems such as a continuous array, where there is no requirement to stitch the individual images together, a singlet lens assembly works reasonably well. When imaging an array comprising a set of sub-arrays displaced from each other in the direction perpendicular to the plane of the arrays a singlet lens assembly may be problematic as it is necessary to bring the imaged dots created by the beams emitted from all the sub-arrays into alignment to form the image. In practice, beams are considered aligned where displacement between two beams in the image plane is less than a maximum acceptable displacement.

Magnification variations resulting from the differing inclination to the optical axis by light emitted from across the array gathered by the singlet lens assembly can result in displacement artefacts in the image. Such artefacts become more significant as the focal length of the singlet lens assembly decreases. In addition the working distance decreases and it becomes more difficult to make a singlet lens assembly with the required focal length. On the other hand, if the focal length of the singlet lens assembly is too long, the lens diameter required to collect all the diverging light increases. This adds additional cost.

Accordingly, the use of a telecentric lensing assembly in place of a singlet les assembly has been proposed. In a perfect telecentric lensing assembly the chief ray (or central ray) from the emitted cone of light from each emitter travels parallel to the optical axis of the telecentric lens assembly at least in the image space. Using such an arrangement, image artefacts resulting from the different emitting locations across the array are reduced and no magnification change occurs where the substrate providing the image plane is displaced. Nevertheless, in practice all lens assemblies have some degree of deviation from telecentricity, defined by a non-telecentric angle Θₜ being the angle made between the chief ray in image space and the optical axis. The deviation from telecentricity results in artefacts, particularly towards the extremes of image area and variations in magnification where the image plane is displaced.

It is therefore an object of the present invention to provide a laser marking system that at least partially alleviates or overcomes the above problems.

### SUMMARY OF THE INVENTION

According to the present invention there is provided a laser marking system for marking an image on a substrate, the system comprising a multi-emitter array, and a telecentric lensing assembly for focusing light emitted from the multi-emitter array on to the substrate wherein the non-telecentric angle, Θₜ, of the telecentric lens assembly satisfies

$$t \leq {tan}^{- 1} ( \frac{{0.714}_{1 \text{/} 2}}{F} )$$

where Θ_{1/2} is the half angle divergence of the emitter beam and 1/F is the fraction of the emitter spot diameter dₒ that corresponds to the maximum acceptable displacement in the image plane.

Use of a telecentric lensing assembly with a non-telecentric angle, Θₜ, satisfying the above inequality ensures that any image artefacts resulting from displacement of image spots marked by different emitters is sufficiently small as not to be discernible to the typical human observer. Such an assembly additionally ensures that any magnification change resulting from substrate displacement can be readily maintained below limits discernible to the typical human observer.

The values of Θ_{1/2} and Θₜ are preferably expressed in radians.

As above a telecentric lens assembly in the present invention has the property that the chief ray (or central ray) from the emitted cone of light deviates from the optical axis of the telecentric lens assembly in image space by less than the non-telecentric angle, Θₜ.

Whilst above, Θ_{1/2} is referred to as the half angle divergence of the emitter beam, Θ_{1/2} the skilled man will appreciate that the present invention equally applies to a converging beam. Accordingly, Θ_{1/2} may be defined as the absolute value of the half angle divergence or convergence of the beam. This provides an accurate outcome in instances, where the emitter beam is converging and hence has a negative divergence half angle.

In some embodiments of the invention, F≥4, preferably, F≥7 and most preferably, F≥10. The higher the value of F, the smaller the acceptable displacement between marked spots in the image plane and hence the higher the quality of the marked image.

In an embodiment. the displacement along the optical axis corresponding to the maximum acceptable displacement of marked spots in the image plane due to magnification variation is equal to the depth of focus of the telecentric lens assembly. In an embodiment, the maximum acceptable displacement of marked spots in the image plane due to magnification variation corresponds to a variation in spot diameter dₒ by a factor of 11/9.

The telecentric lens assembly may comprise a lens pair. The lens pair may comprise an input lens closest to the array and an output lens closest to the substrate. The lenses of the lens pair may be separated by a distance equal to the sum the focal lengths of each lens of the pair.

Nevertheless, the skilled man will appreciate that lenses with slightly different focal lengths and separations not identically equal to the sum of the focal lengths are also covered by the invention. In particular, such lens pairs may satisfy the present invention where the magnification changes resulting from variation in lens position do not exceed particular tolerances. For example, an optical system that is not fully telecentric in the object space can have small magnification changes due to small displacements of the emitter rays from the preferred emitter plane.

The separation between the front lens and the array may be equal to or of the order of the focal length of the input lens. This separation is half that required for a singlet lens assembly with unity magnification of the same focal length. Accordingly, the use of a telecentric lensing assembly can reduce the separation between the array and the lensing assembly as compared with use of a singlet lens assembly. The reduced separation enables a smaller diameter lensing assembly to be used compared to singlet lens assemblies or for larger arrays to be imaged with a lens assembly of a given diameter. The use of a telecentric lens assembly also has the advantage over a singlet lens assembly that magnification is independent of the separation between the array and the input lens. Accordingly a system incorporating a telecentric lens assembly is much less sensitive to mechanical tolerances than a system incorporating a singlet lens assembly.

In some embodiments, the focal length of the output lens may be varied to vary the magnification. Beneficially such adjustments may be made with no change to the input lens diameter. This therefore ensures efficient collection of emitted light.

In some embodiments, each lens of the lens pair may comprise a number of elements. The different elements may be adapted to correct for aberrations. The corrected aberrations may include chromatic aberrations, astigmatism and field curvature.

The multi-emitter array may comprise a multi-fibre array. In such embodiments, the multi-fibre array may comprise an array of emitting ends of optical fibres, each fibre coupled to a laser source at the opposing end. In other embodiments, the multi-emitter array may comprise an array of laser sources.

The marking system may comprise a marking controller. The marking controller may be operable to control the operation of the laser sources. In some embodiments, the marking controller may be operable to control the operation of the laser sources by way of laser drivers connected between the marking controller and each laser source.

The multi-emitter array may be arranged in a single one dimensional or two dimensional array. Alternatively, the multi-emitter array may be arranged in a two or more one dimensional or two dimensional sub-arrays. The sub-arrays may be displaced from one another in a direction perpendicular to the plane of the arrays. In some such embodiments, alternate sub-arrays are displaced either side of a common axis. In some such embodiments, the displacement s between sub-arrays satisfies:

s≤f/16

where f is the focal length of the input lens or output lens.

In some embodiments, each sub-array is tilted relative to an axis perpendicular to the direction of relative motion between the multi-emitter array and the substrate In a preferred embodiment, the difference in angle α between adjacent sub-arrays from one array to the next should satisfy

$$α \leq {tan}^{- 1} ( \frac{{d}_{o}}{2 FW} )$$

where W is the width of the array in mm.

The lensing assembly and the multi-emitter array may together comprise an imaging head. In some embodiments the laser marking system may be provided with two or more imaging heads, each imaging head comprising a single one dimensional or two dimensional array multi-emitter array and an independent lensing assembly.

The marking system may be provided with a position sensor operable to monitor the motion of the substrate relative to the imaging head. Suitable forms of position sensor include but are not limited to magnetic or optical sensors or the like. Such magnetic or optical sensors may comprise rotary or linear position encoders or the like.

The position sensor may be operable to output a signal indicative of the position of the substrate to a marking controller. The output signals may comprise pulses or encoder counts. The number of pulses or encoder counts output may be dependant on the position of the substrate. The marking controller may be operable to store a pulse or encoder count received from the position sensor.

Preferably, the position sensor has a minimum resolution ‘res’ that satisfies

res≤dₒ/20

where dₒ is the spot size of light emitted from each fibre at the substrate.

The marking controller may be operable to delay laser activation in response to the number of pulses or encoder counts output by the position sensor or the stored pulse or encoder count. In this manner, the marked image is brought into alignment in compensation for movement of the substrate. In one embodiment, the number of pulses or encoder counts is proportional to the distance travelled by the substrate.

The generation of pulses or encoder counts may be varied in response to the magnification provided by the lensing assembly and/or the array resolution. Alternatively, the stored pulse or encoder count may be adjusted in response to the magnification provided by the lensing assembly and/or the array resolution. The adjustment may be carried out by the marking controller.

In embodiments with multiple arrays or sub-arrays, the stored pulse or encoder count may be adjusted for each separate array or sub-array. This enables parts of an image marked by different arrays or sub-arrays to be aligned. This is a benefit in contrast to systems that do not use a telecentric lens assembly, as these would require the delay count to be continuously calculated.

In embodiments comprising a multi-fibre array, the fibres in the array may have any suitable dimensions. In one embodiment, the fibres in the array may have core diameters in the range 45 to 120 μm. A preferred core diameter may be of the order of 105 μm. In some embodiments, the fibres in the array may have numerical apertures of less than around 0.24. In further embodiments, the fibres in the array may have numerical apertures in the range 0.1 to 0.25, preferably 0.13 to 0.22, more preferably in the range 0.11 to 0.17, or the like. In some embodiments, the pitch of the array may be between around 60 μm and around 130 μm. Preferably, the pitch may be around 127 μm.

The substrate may comprise a colour change material operable to change colour in response to illumination by the lasers. The colour change material may comprise substances including but not limited to any of: a metal oxyanion, a leuco dye, a diacetylene, a charge transfer agent or the like. The metal oxyanion may be a molybdate. In particular, the molybdate may be ammonium octamolybdate (AOM). The colour change material may further comprise an acid generating agent. The acid generating agent may comprise thermal acid generators (TAG) or photo-acid generators (PAG). In one embodiment, the acid generating agent may be an amine salt of an organoboron or an organosilicon complex. In particular, the amine salt of an organoboron or an organosilicon complex may be tributyl ammonium borodisalicylate.

The substrate may comprise an NIR (near infrared) absorber material. The NIR absorber material may be operable to facilitate the transfer of energy from an NIR laser illumination means to the colour change material. The NIR absorber material may comprise substances including but not limited to any of: Indium Tin Oxide (ITO), non-stoichiometric reduced ITO, Copper Hydroxy Phosphate (CHP), Tungsten Oxides (WOₓ), doped WOₓ, non-stochiometric doped WOₓ and organic NIR absorbing molecules such as copper pthalocyanines or the like.

The laser sources may comprise any suitable type of laser. In a preferred embodiment, the lasers are laser diodes.

The lasers may have any suitable operating wavelength. In particular, the lasers may have an operating wavelength in the range 200 nm to 20 μm. In particular, the lasers may have an operating wavelength in any one or more of the following regions: 900-1500 nm; 395-470 nm; 500-810 nm or the like.

The lensing assembly may be formed from any suitable material. In this context, suitable materials include, but are not limited to Zinc Sulphide (ZnS), fused silica, Borosilicate, Crown Glass, Flint Glass or the like.

### DETAILED DESCRIPTION OF THE INVENTION

In order that the invention may be more clearly understood one or more embodiments thereof will now be described, by way of example only, with reference to the accompanying drawings, of which:

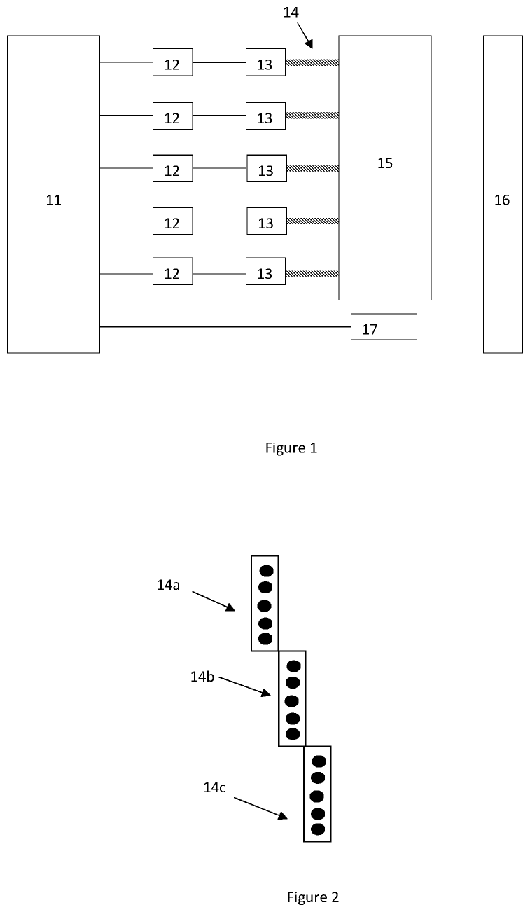

FIG. 1 is a schematic block diagram of a laser marking system according to the present invention;

FIG. 2 is a schematic illustration of an imaging head for a multi-emitter laser marking array comprising a plurality of staggered sub-arrays;

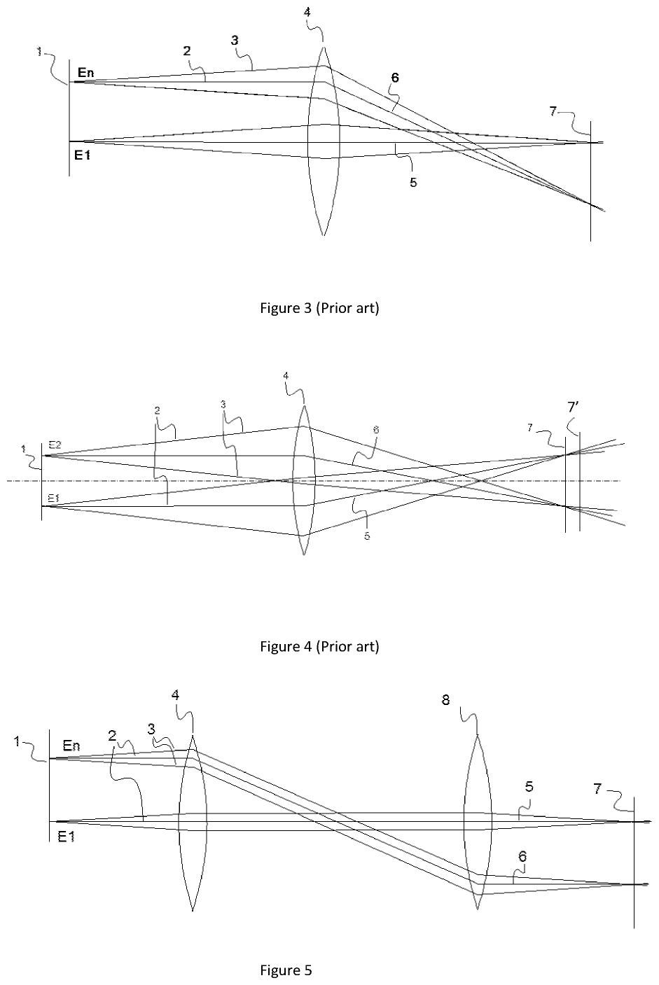

FIG. 3 is a schematic ray diagram of a prior art laser marking system comprising multiple emitters on an emitter plane;

FIG. 4 is a schematic ray diagram of the prior art laser marking system of FIG. 3 from a direction perpendicular to the optical axis and the orientation of FIG. 3;

FIG. 5 is a schematic ray diagram of a laser marking system incorporating an ideal telecentric lens assembly in accordance with the present invention;

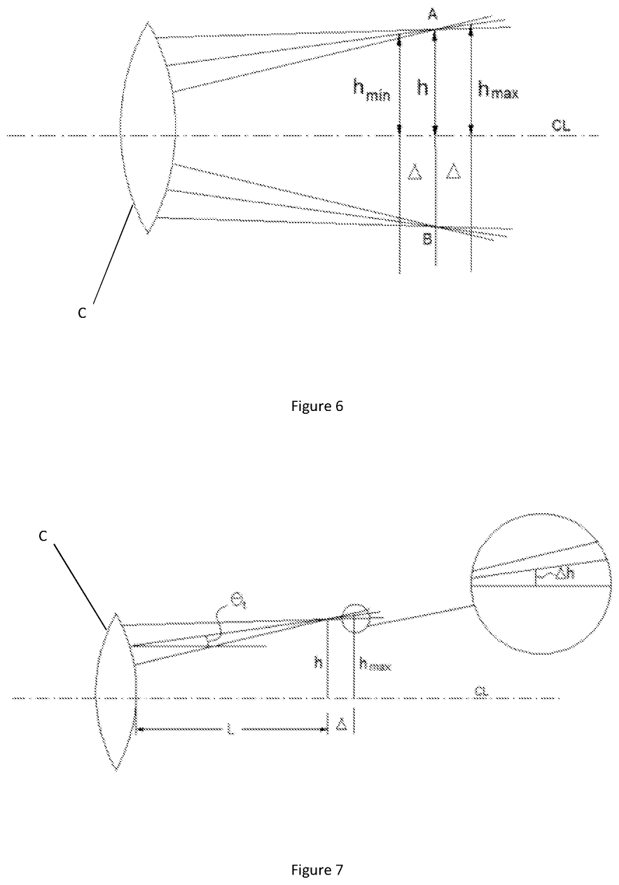

FIG. 6 is a schematic ray diagram illustrating deviations from telecentricity in a practical implementation of a laser marking system incorporating an telecentric lens assembly in accordance with the present invention; and

FIG. 7 is a schematic ray diagram illustrating the calculation of the maximum allowable deviation from telecentricity in a laser marking system incorporating a telecentric lens assembly in accordance with the present invention.

Turning to FIG. 1, a laser marking system 10 comprises a marking controller 11 operable to control a plurality of laser drivers 12. Each laser driver 12 is operable to drive an associated laser diode 13. The outputs of the lasers diodes 13 are each coupled to a first end of an associated optical fibre 14. The second, emitting, ends of the optical fibres 14 form a multi-emitter array. Light emitted from the emitting ends of the optical fibres 14 is focussed by a lensing arrangement 15 on a substrate 16. The skilled man will however appreciate that the invention may equally be applied to a multi-emitter array comprising an array of directly emitting laser diodes.

The substrate 16 comprises a colour change material which undergoes a colour change in response to exposure to laser light. Relative motion between the substrate 16 and the lensing assembly 15, typically the substrate 16 being moved past the lensing assembly 15, and modulation of the output of the laser diodes 13 in response to the marking controller 11 results in an image being marked on the substrate 16.

In some embodiments, the optical fibres 14 can form a single simple one dimensional or two dimensional array. In other embodiments, as is illustrated in FIGS. 2a and 2b, the optical fibres 14 can form a staggered array comprising a series of sub-arrays 14a, 14b, 14c, or series of sub-arrays 14e, 14f, 14g. In FIG. 2a each sub-array 14a, 14b, 14c displaced from the adjacent sub-array 14a, 14b, 14c in a direction perpendicular to the direction of travel of the substrate 16 such that alternating sub-arrays lie substantially on the same plane. In FIG. 2b the sub-arrays 14e, 14f, 14g are displaced in a stepwise manner. The sub-arrays 14a, 14b, 14c, 14e, 14f, 14g may be one dimensional as shown in FIG. 2 or two dimensional as required. The configuration shown in FIG. 2a is preferred as the displacement either side of the centre is substantially constant. This minimises the performance requirements of the lens and also limits the number of offset counts and problems with material stretch or the like, which become more serious as the separations get larger

The system 10 can also be provided with a position sensor 17 operable to monitor the position and motion of the substrate 16. The position sensor 17 is operable to output a signal indicative of the position of the substrate 16, typically in the form of a pulse or more preferably an encoder count. The marking controller 11 operable to store the encoder count received from the position sensor 17.

The marking controller 11 is operable to delay laser activation in response to the encoder count. In this manner, the marked image on the substrate 16 is brought into alignment in compensation for movement of the substrate 16 relative to each displaced sub-array. In embodiments with multiple sub-arrays 14a, 14b, 14c, or 14e, 14f, 14g the encoder count may be adjusted for each separate sub-array 14a, 14b, 14c or 14e, 14f, 14g. This enables parts of an image marked by different sub-arrays 14a, 14b, 14c, or 14e, 14f, 14g to be aligned reliably.

The lensing assembly 15 in the prior art would comprise a singlet lens assembly comprising either a single lens or may be a lens combination acting as a single imaging lens. In the present invention, the lensing assembly 15 is a telecentric lensing assembly. In the present invention, a telecentric lens assembly has the property that the chief ray from the emitted cone of light from each emitter travels parallel or substantially parallel to the optical axis at least in the image space. In particular, the telecentric lens assembly has the property that the chief ray from the emitted cone of light from each emitter travels parallel to or substantially parallel to the optical axis in the image space and object space. For the purposes of this invention, a ray travelling at an angle to the optical axis of less than or equal to 2 degrees may be considered substantially parallel.

Use of a telecentric lensing assembly reduces image artefacts resulting from the different emitting locations across the array better than use of a singlet lens assembly. Additionally, use of a telecentric lens assembly ensures that there is no magnification change or only a small magnification change where the substrate providing the image plane is displaced. This is illustrated by contrasting the operation of a singlet lens assembly as shown in to FIGS. 3 and 4 with operation using a telecentric lensing assembly in FIG. 5.

Turning now to FIG. 3, is a ray diagram is shown illustrating the use of a singlet lens assembly 4 comprising a single lens 4 to focus light emitted from a multi-emitter array. In this instance the emitting ends of fibres 14 are represented by emitters E1 to En located at the emitter plane 1. In this example, motion of the substrate 16, here represented by image plane 7 would be into or out of the page. Emitter E1 is located on the optical axis and emitter En located some distance from the optical axis in the plane 1 of the array. The configuration of lens and object distance shown results in 1:1 magnification. The chief ray 2 and marginal rays 3 of the emitters E1, En are shown in the object space to the left of the lens 4. In each case, the chief ray 2 is parallel to the optical axis of lens 4.

In the image space to the right of the lens 4, the chief ray 5 of the emitter E1 located on the optical axis is parallel to the optical axis of lens 4. In contrast, in the image space, the chief ray 6 of emitter En makes a significant angle with the optical axis of lens 4. It is clear then that any change in the location of the image plane 7 (substrate 16) results in a greater or smaller magnification for emitters En further from the optical axis.

Whilst a magnification change in this lateral direction does not affect the displacement of staggered sub-arrays it does have an impact on marking configurations that use continuous arrays imaged by separate lenses and displaced from each other. Any change in the image plane of one head can alter the magnification and this may result in a relative displacement between the images produced by the two arrays. Such a visual artefact is undesirable.

Turning now to FIG. 4, this also illustrates use of a single lens assembly but with substrate 16 motion perpendicular to that shown in FIG. 3 (up and down the page). In this instance, E1 and E2 represent emitters from two staggered sub-arrays located in the object plane 1 either side of the optical axis of lens 4. In this case the chief rays 2 from both E1 and E2 are parallel to the optical axis. Rays 3 represent the marginal or outer rays determined by the divergence of the emitters E1, E2. Lens 4 images the emitters onto the substrate 16 as represented by image plane 7. In the image space to the right of the of the lens the chief ray 5 from emitter E1 makes an upward angle to the optical axis and chief ray 6 from emitter E2 makes a downward angle to the optical axis. In the event that the substrate 16 moves to position 7′ the magnification provided by lens 4 will increase and hence image size will increase. In this case the magnification change is the same for all emitters in the sub-array.

Whether such a shift in image plane 7 has an impact in terms of visible artefacts in the final image depends on the particular properties of the system. Typically, fibre arrays used for high power image marking are typically multimode with numerical apertures (NA) in the range 0.1 to 0.25, such as the industry standard values 0.15 or 0.22. Using such fibres the depth of focus for good image quality is in the region of +/−0.4 mm, accordingly, it may be thought that variation through this limited depth of focus would be too small to make a significant impact on magnification. Nevertheless, for a system using a lens 4 with focal length 40 mm focal length imaging at 1:1, with the object plane 1 at a separation of 80 mm from the lens, the change in magnification due to a displacement of +/−0.4 mm results in the image moving by +/−0.025 mm for each array. At a resolution of 200 dpi this is clearly visible to the naked eye in the printed image. If single mode fibres that are coupled to laser diodes of sufficient power from the fibre laser array then the depth of focus becomes many times greater and the problem is amplified.

Turning now to FIG. 5, a schematic ray diagram for marking using a multi-emitter array is shown where the lensing arrangement 15 is an ideal telecentric lensing arrangement comprising a lens pair: an input lens 4; and an output lens 8. In FIG. 5 emitters E1 and En are located at the object plane 1, with E1 being located on the optical axis of telecentric lens pair 4, 8 and En being located away from the optical axis. The chief rays 2 from E1 and En are parallel to the optical axis in the object space prior to input lens 4. The spread of light from the emitters E1, En is represented by the marginal rays 3. Between lenses 4, 8 the rays from emitter En are inclined with respect to the optical axis of lenses 4, 8. In the image space past output lens 8, the chief ray 6 from emitter is parallel to the axis as is the chief ray 5 from emitter E1. In this case movement in the image plane 7 has no impact on the magnification. Consequently, there is no movement of image dots with focal plane changes and therefore no artefacts in the image.

Nevertheless, in practice all lens assemblies have some degree of deviation from telecentricity. As a result, variations in set up or alignment may still result in image artefacts, particularly towards the extremes of image area and variations in magnification where the image plane is displaced. Such artefacts may be eliminated or at least kept below levels discernible by a human by maintaining limits on deviation from an ideal arrangement as discussed below.

Turning now to FIG. 6, two staggered arrays are imaged through a notionally telecentric lens assembly C. As illustrated, in image space the lens assembly C is not perfectly telecentric. At best focus, the distance of each image position A, B from the optical axis is represented by the distance h. The displacement between the two image locations in the image plane at best focus (where a substrate would ideally be located) is therefore 2h. In use, a substrate would typically be travelling relative to the lens assembly C in in the direction from A to B. As such, the timing of emissions from emitters in the array corresponding to image B will be delayed until the image formed at A is in the correct location. Typically, this delay is set as a fixed number P of encoder counts from a position sensor that outputs a pulse when the substrate or target has moved an incremental distance and where P times the incremental distance equals the distance 2h.

If the plane of the substrate is displaced from the plane of best focus by a distance Δ then the separation of the image A, B from the centre line can vary from hₘₐₓ to hₘᵢₙ. This defines a consequent separation in the image plane Δh. It is clear that in this context, the maximum resultant separation in the image plane is 2Δh. In order for an acceptable image quality to be achieved, 2Δh must not exceed the maximum acceptable displacement in the image plane either as discernible by a typical human eye or as is required for the desired image quality. Typically, this maximum acceptable separation is defined in terms of fractions of the emitter spot diameter dₒ. in one example, the maximum acceptable separation is less than or equal to dₒ/4, preferably, less than or equal to dₒ/7 and most preferably less than or equal to dₒ/10.

If the plane of the substrate is displaced from the plane of best focus, it is evident that the encoder count number P will not be correct and the image formed at B will not line up with the image formed at A.

Turning now to FIG. 7, the position of the focus of a single array only is considered for simplicity. In a staggered array system as is illustrated in FIG. 2, the position of the additional array or arrays would be mirrored to the other side of the centre line CL.

In FIG. 7, L is the distance from the lensing assembly C to the image plane. As discussed previously, h is the displacement of the array image from centre line CL, hₘₐₓ is displacement of the array image from centre line CL the image plane to lensing assembly distance has increased by a distance Δ, and Δh=hₘₐₓ−h. In such a system, the non-telecentric angle, Θₜ, corresponds to the angle the chief ray in the image space makes with the optical axis along centre line CL.

For a practical working implementation of a laser marking system, we can set the displacement Δ to equate to the depth of focus of the lensing assembly C. The depth of focus is an arbitrary distance over which the image plane may vary whilst maintaining and acceptable image quality. For practical purposes, this is generally much less that the Rayleigh range quoted in the literature which is defined by reference to the distance at which the emitter spot area has increased by a factor of 2. This corresponds to a linear scale factor of √2. In the present invention, it has however been found that smaller linear scale factor of 11/9 is required for acceptable image quality.

Bearing the above in mind, if Z_{DOF} is the distance where beam diameter has increased by 11/9, it is possible to define Z_{DOF} by either:

$${Z}_{DOF} = \frac{2.2 {ω}_{o}^{2}}{{M}^{2} λ}$$

$$or$$

$${Z}_{DOF} = \frac{2.2 {ω}_{o}}{{πΘ}_{1 \text{/} 2}}$$

where Θ_{1/2} is the absolute value of the half angle divergence of the laser beam, ωₒ is the beam radius at the waist (2ωₒ=dₒ), M² is the beam quality factor and λ is the beam wavelength. In instances, where the emitter beam is converging and hence has a negative divergence half angle, the absolute value of Θ_{1/2} is essentially the half angle convergence of the beam.

Considering FIG. 7, it is also clear that:

Δh=Δ·tan Θₜ

As in practice there will be arrays displaced in the direction of product motion either side of centre line CL, then the distance between the image planes may change by 2Δh. Furthermore, since the displacement Δ can be positive and negative then the maximum difference in the separation in the image plane could be 2(hₘₐₓ−hₘᵢₙ) or 4Δh.

As discussed above, for acceptable image quality, the maximum displacement in the image plane should be less than a suitable fraction 1/F (say ¼, 1/7 or 1/10 as quoted above) of the emitter spot diameter dₒ. Hence:

$$4 Δ h \leq \frac{2 {ω}_{o}}{F}$$

If Δ=Z_{DOF}, then:

$$2 Δ h = 2 {Z}_{DOF} tan {Θ}_{t} \leq \frac{{w}_{o}}{F}$$

By substitution from the definition of Z_{DOF} above, we can derive the expression below:

$${Θ}_{t} \leq {tan}^{- 1} ( \frac{0.714 {Θ}_{1 \text{/} 2}}{F} )$$

This therefore defines the upper limit of the non-telecentric angle Θₜ for a particular acceptable image quality with reference to an acceptable displacement in the image plane defined in fractions of the emitter spot diameter dₒ.

In order to limit artefacts due to the motion of the array, the resolution (res) of the position sensor should satisfy:

res≤dₒ/20

where res is the required resolution.

In the case of arrays comprising a plurality of staggered sub-arrays, in order to limit artefacts and edge effects, the displacement ‘s’ of the sub-array from the optical axis should satisfy

s≤f/16

where f if the focal length the lensing assembly, or, in the case of a lens pair, the focal length of the input or output lens.

Where respective sub-arrays are tilted, in order to minimise artefacts due to tilting of the array, the maximum difference in sub-array tilt angle α relative to an axis perpendicular to the direction of relative motion between array and substrate should satisfy

$$α \leq {tan}^{- 1} ( \frac{{ω}_{o}}{FW} )$$

where W is the width of the array in mm.

The above embodiments are described by way of example only. Many variations are possible without departing from the scope of the invention as defined in the appended claims.

1. A laser marking system for marking an image on a substrate, the system comprising a multi-emitter array, and a telecentric lensing assembly for focusing light emitted from the multi-emitter array on to the substrate wherein the non-telecentric angle, Θₜ, of the telecentric lens assembly satisfies
$${θ}_{t} \leq {tan}^{- 1} ( \frac{0.714 {θ}_{1 \text{/} 2}}{F} )$$
where Θ_{1/2} is the half angle divergence of the emitter beam and 1/F is the fraction of the emitter spot diameter dₒ that corresponds to the maximum acceptable displacement in the image plane.

2. A laser marking system as claimed in claim 1 wherein F≥4.

3. (canceled)

4. (canceled)

5. A laser marking system as claimed in claim 1 wherein the displacement along the optical axis corresponding to the maximum acceptable displacement of marked spots in the image plane due to magnification variation is equal to the depth of focus of the telecentric lens assembly.

6. A laser marking system as claimed in claim 5 wherein the maximum acceptable displacement of marked spots in the image plane due to magnification variation corresponds to a variation in spot diameter dₒ by a factor of 11/9.

7. A laser marking system as claimed in claim 5 wherein the separation between the front lens and the array is equal to or of the order of the focal length of the input lens.

8. (canceled)

9. A laser marking system as claimed in claim 1 wherein the multi-emitter array comprises an array of laser sources.

10. A laser marking system as claimed in claim 1 wherein the multi-emitter array is arranged in two or more one dimensional or two dimensional sub-arrays, the sub-arrays displaced from one another in a direction perpendicular to the plane of the arrays.

11. A laser marking system as claimed in claim 10 wherein the displacement s between sub-arrays satisfies:
s≤f/16
where f is the focal length of the input lens or output lens.

12. A laser marking system as claimed in claim 10 wherein each sub-array is tilted relative to an axis perpendicular to the direction of relative motion between the multi-emitter array and the substrate.

13. A laser marking system as claimed in claim 12 wherein the tilt angle α of each sub-array relative to an axis perpendicular to the direction of relative motion between array and substrate satisfies:
$$α \leq {tan}^{- 1} ( \frac{{d}_{o}}{2 FW} )$$
where W is the width of the sub-array.

14. A laser marking system as claimed in claim 1 wherein the lensing assembly and the multi-emitter array together comprise an imaging head.

15. (canceled)

16. A laser marking system as claimed in claim 1 wherein the marking system is provided with a position sensor operable to monitor the motion of the substrate relative to the multi-emitter array and output a signal indicative of the position of the substrate to a marking controller, wherein the output signals comprise pulses or encoder counts, the number of pulses or encoder counts output dependant on the position of the substrate.

17. (canceled)

18. A laser marking system as claimed in claim 16 wherein the resolution (res) of the position sensor satisfies:
res≤dₒ/20.

19. A laser marking system as claimed in claim 16 wherein the marking controller is operable to compare the pulse or encoder count received from the position sensor with a count value stored in the controller.

20. A laser marking system as claimed in claim 16 wherein the marking controller is operable to delay laser activation in response to the number of pulses or encoder counts output by the position sensor or the stored pulse or encoder count.

21. A laser marking system as claimed in claim 16 wherein the generation of pulses or encoder counts is varied in response to the magnification provided by the lensing assembly and/or the array resolution.

22. A laser marking system as claimed in claim 17 wherein the stored pulse or encoder count is adjusted in response to the magnification provided by the lensing assembly and/or the array resolution.

23. A laser marking system as claimed in claim 22 wherein the stored pulse or encoder count is adjusted for each separate array or sub-array.

24. A laser marking system as claimed in claim 1 wherein the substrate comprises a colour change material operable to change colour in response to illumination by the lasers, the colour change material being any of: a metal oxyanion, a leuco dye, a diacetylene, or a charge transfer agent.

25. A laser marking system as claimed in claim 1 wherein the substrate comprises an NIR (near infrared) absorber material.
